(19) United States
(12) Patent Application Publication
(10) Pub. No.: US 2021/0224525 A1
(43) Pub. Date: Jul. 22, 2021

(54) HYBRID DISPLAY SYSTEM WITH MULTIPLE TYPES OF DISPLAY DEVICES

(71) Applicant: Shenzhen Jingjiang Yunchuang Technology Co., Ltd., Shenzhen (CN)

(72) Inventors: XUE-QIN ZHANG, Shenzhen (CN); JUKA OH, Shenzhen (CN)

(21) Appl. No.: 17/131,318

(22) Filed: Dec. 22, 2020

(30) Foreign Application Priority Data
Jan. 21, 2020 (CN) 202010069648.X

(51) Int. Cl. G06K 9/00; G06F 3/01; G03B 21/14

(52) U.S. Cl. CPC G06K 9/00355; G06F 3/017; G03B 21/14; G06K 9/00255; G06K 9/00248

(57) ABSTRACT

A hybrid display system supporting multiple modes of display for increased and more immersive user participation includes a display device set, a sound playing device, a content input device, and a control device. The display device set includes several types of display devices. The content input device inputs display content to the display device set and the sound playing device. The control device is configured for allowing a user to set a display mode of the display device set. The display mode comprises an interactive display mode, a non-interactive display mode, and a hybrid display mode combining the interactive display mode and the non-interactive display mode.

### FIELD

The subject matter herein generally relates to displays.

### BACKGROUND

Methods for outputting information generally include a display screen or a combination of display screen and loudspeaker. A user can watch video content through the display screen and listen to any associated audio track. The output of information is relatively simple, and a viewer does not receive a complete and interactive experience in relation to the presentation.

Thus, there is room for improvement.

### BRIEF DESCRIPTION OF THE DRAWINGS

Implementations of the present disclosure will now be described, by way of embodiments, with reference to the attached figures.

FIG. 1 is a block diagram of an embodiment of a hybrid display system.

FIG. 2 is a diagram of an embodiment of mapping relation between input contents of multiple interfaces and multiple display devices of the hybrid display system of FIG. 1.

FIG. 3 is a flow diagram of an embodiment of a method for performing an interactive display of the hybrid display system of FIG. 1.

FIG. 4 shows a scene illustrating an embodiment of the hybrid display system of FIG. 1.

FIGS. 5 and 6 are diagrams of an embodiment of mapping relation between multiple interactive activities and multiple control commands.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

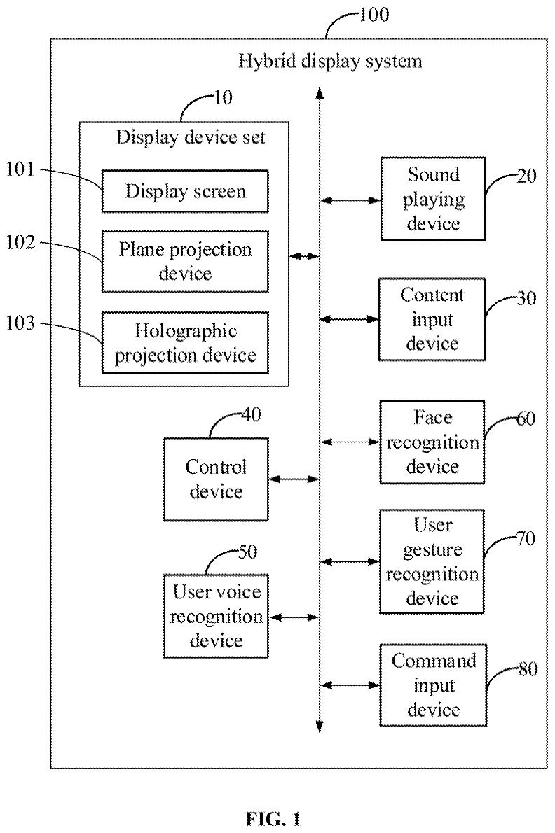

FIG. 1 illustrates a hybrid display system 100 in accordance with an embodiment. The hybrid display system 100 comprises a display device set 10, a sound playing device 20, a content input device 30, a control device 40, a user voice recognition device 50, a face recognition device 60, a user gesture recognition device 70, and a command input device 80. The display device set 10 comprises at least two different types of display devices. The at least two different types of display devices can be selected from the group comprising of display screens, plane projection devices, and holographic projection devices.

For example, the display device set 10 can comprise one display screen and one holographic projection device, or one plane projection device and one holographic projection device, or one display screen and one plane projection device, or one display screen, one plane projection device, and one holographic projection device, or one display screen, one plane projection device, and two holographic projection devices, or multiple display screens and holographic projection devices. The display screen can be a liquid crystal display (LCD) screen or a light emitting diode (LED) screen. In FIG. 1, the display device set 10 comprises a display screen 101, a plane projection device 102, and a holographic projection device 103 for example.

In one embodiment, a projection angle between the plane projection device can be adjusted through 120 degrees. When the display device set 10 comprises a display screen and a plane projection device, an installation angle between the display screen and the plane projection device may be 180 degrees (the display screen being installed opposite to the plane projection device). When the display device set 10 comprises a display screen and a holographic projection device, an installation angle between the display screen and the holographic projection device may be 90 degrees. When the display device set 10 comprises a plane projection device and a holographic projection device, an installation angle between the plane projection device and the holographic projection device may be 90 degrees. In other embodiments, the above installation angles can also be adjusted according to a need for actual display.

The sound playing device 20 is configured for sound playback. The sound playing device 20 can comprise at least one speaker or speaker box. The content input device 30 is configured for inputting display content to the display device set 10 and the sound playing device 20.

For example, the display device set 10 and the sound playing device 20 may comprise a video graphics array (VGA) interface, a digital visual interface (DVI), a high definition multimedia interface (HDMI), a universal serial bus (USB) interface, and a definition multimedia interface (DMI). The content input device 30 comprises multiple content input interfaces. The content input interfaces can comprise a VGA interface, a DVI, an HDMI, a USB interface, and a DMI. Then, the content input device 30 can be matched with the interfaces of the display device set 10 and the sound playing device 20. The content input device 30 can input the display content into the display device set 10 and the sound playing device 20 through the multiple content input interfaces. The display content may be videos, audios, pictures, texts, etc.

In one embodiment, the content input device 30 can be a computer, a mobile phone, a server, etc.

The control device 40 is configured for allowing a user to set a display mode of the display device set 10. For example, the display mode comprises an interactive display mode, a non-interactive display mode, and a hybrid display mode combining the interactive display mode and the non-interactive display mode.

In a non-interactive display mode, a specific content XX1 is displayed on a specific device YY1 in a specific time ZZ1, or a specific content XX2 is displayed on a specific device YY2 and a specific device YY3 at the same time in a specific time ZZ2. In the non-interactive display mode, a playing sequence or a display rule are predetermined, which is different from human-computer interaction control. In the interactive display mode, the content to be played is controlled by human-computer interaction. There are no predetermined playback sequences or predetermined display rules defined in the interactive display mode. The interactive display mode can comprise a somatosensory interaction (body actions or gestures), a voice interaction, a expression interaction, etc.

For example, in the interactive display mode, interactive activities by a user can open webpages, visit websites, operate one or more applications, perform interactive collaborative programming of a program, perform music creation, perform music editing, perform film and television creation, perform artworks creation, perform clothing design creation, costume design creation, and sculpture creation.

In one embodiment, the interactive display mode can be developed to support a network and a cloud platform. The interactive display mode can be developed as a programming software supported human-computer interaction, a painting software supported human-computer interaction, an operating table remote control software, a music editing software supported human-computer interaction, a film and television creation software supported human-computer interaction, an art creation software supported human-computer interaction, a clothing design software supported human-computer interaction, a costume design software supported human-computer interaction, and a sculpture creation software supported human-computer interaction.

The hybrid display mode can comprise some content that is predetermined and fixed to display or play, and other content is determined by live interaction. The hybrid display mode can be used in a concert scene or training scene, for example.

In one embodiment, the control device 40 can be a processing chip, a computer, or a server.

The user voice recognition device 50 is configured to capture and recognize sounds, and the user voice recognition device 50 can comprise one or more microphones or pickups. The face recognition device 60 is configured to capture and recognize images, and the face recognition device 60 can comprise one or more cameras. The user gesture recognition device 70 is configured to capture and recognize body posture information, and the user gesture recognition device 70 can comprise one or more three dimensional (3D) image sensors. The command input device 80 is configured for allowing the user to manually an input control command, and the command input device 80 can be a mouse, a keyboard, a brain-computer interface, or smart glasses.

In one embodiment, in the non-interactive display mode, each of the content input interfaces is configured to allow transmission of the display content to the respective display device, a playback rule of the display content can be defined as:
a). videos, pictures, texts are output by the display screen in default;
b). audios are output by the speaker in default;
c). relationships between each of the content input interfaces and each of the display devices are predefined; and
d). labeled information is preset in the display content, and the labeled information is configured for indicating corresponding display device to play the display content.

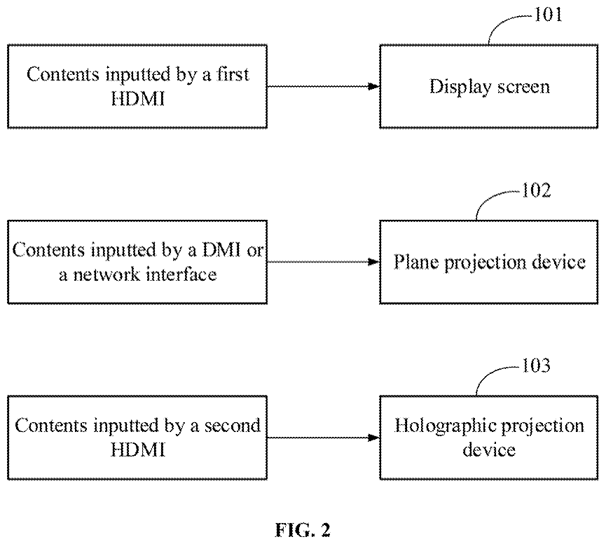

Referring to FIG. 2, the display screen 101 corresponds to contents inputted by a first HDMI, the plane projection device 102 corresponds to contents inputted by a DMI or a network interface, and the holographic projection device 103 corresponds to contents inputted by a second HDMI. Then, if contents are detected to be inputted by the first HDMI, the display device set controls the display screen to display that contents. If contents are detected to be inputted by the DMI or the network interface, the display device set controls the plane projection device to display that contents. If contents are detected to be inputted by the second HDMI, the display device set controls the holographic projection device to display that contents. In other embodiments, the holographic projection device 103 can correspond to contents inputted by the second HDMI and a VGA interface.

In one embodiment, videos comprise first labeled information to be displayed on the display screen. Images and texts comprise second labeled information to be displayed on the plane projection device. Contents with holographic projection playback conditions comprise third labeled information to be displayed on the holographic projection device.

In one embodiment, when the display device set 10 operates in the interactive display mode, operations of the display device set 10 can comprise a gesture controlled operation, a voice controlled operation, a system interface control operation, a manually input control operation, and a mixed control operation. The mixed control operation comprises at least two of the gesture controlled operation, the voice controlled operation, the system interface control operation, and the manually input control operation.

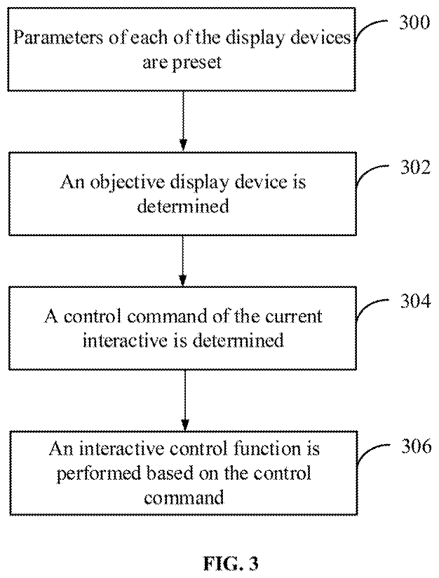

FIG. 3 illustrates one exemplary embodiment of a method for performing an interactive display of the display device set 10. The flowchart presents an exemplary embodiment of the method. The exemplary method is provided by way of example, as there are a variety of ways to carry out the method. Additional blocks can be added or fewer blocks may be utilized, without departing from this disclosure. The example method can begin at block 300.

In block 300, parameters of each of the display devices are preset.

In one embodiment, the parameters of each of the display devices can be preset according to an actual requirement. For example, some parameters of each of the display devices can be preset as a default. Such parameters can comprise a resolution of the display screen, a spot parameter, a light path parameter, a hue parameter, and a focal length parameter of the plane projection device or the holographic projection device.

In block 302, an objective display device is determined.

In one embodiment, the control device 40 can determine whether the contents are displayed on the display screen, or displayed on the plane projection device, or displayed on the holographic projection device. The control device 40 can further determine whether commands are configured to control which display screen, or configured to control which plane projection device, or configured to control which holographic projection device. For example, the objective display device is the screen or device that a user is currently facing.

In block 304, a control command of the current interactive mode is determined.

In one embodiment, when an interactive activities is detected, the control device 40 can identify the control command represented by the interactive activities according to a predetermined rule. The predetermined rule can comprise mapping a relation between multiple interactive activities and multiple control commands.

In block 306, an interactive control function is performed based on the control command.

In one embodiment, when the objective display device is determined and the control command of the current interactive mode is determined, the interactive control function can be performed on the objective display device based on the control command.

In one embodiment, the gesture controlled operation can comprise a user using his hands, arms, legs, feet, and others to implement multiple control functions on the display device set 10. The multiple control functions can comprise a movement-up function, a movement-down function, a movement-left function, a movement-right function, a page-turning function, a head-nodding (confirming) function, a cancel function, a return function, a selecting function, a zoom-in function, and a zoom-out function.

When the display device set 10 is controlled under the gesture controlled operation, the control device 40 is configured to choose the corresponding display device and control the corresponding display device according to gestures of the user. The control device 40 can further determines what or which control command is represented by the gestures of the user and performs an interactive control on the corresponding display device accordingly.

In one embodiment, a rule of determining an objective display device can be the control device 40 choosing a display device that is activated a face recognition in front of a face of a user as the objective display device, and the current gesture is generated by the user.

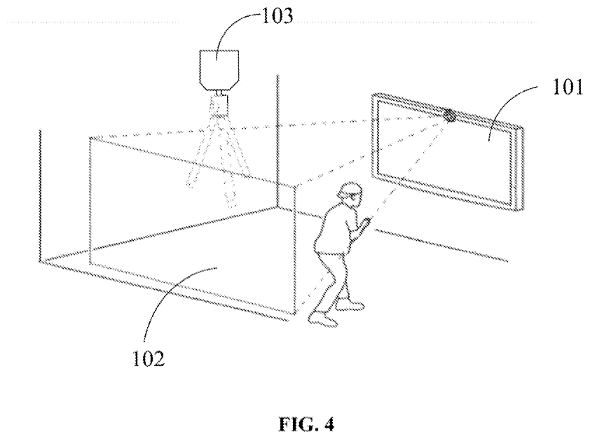

Referring to FIG. 4, the installation angle between the display screen and the plane projection device is 180 degrees, the installation angle between the display screen and the holographic projection device is 90 degrees, the installation angle between the plane projection device and the holographic projection device is 90 degrees, and the user is facing the display screen (a face recognition angle between the face of the user and the display screen is 90 degrees or square on). Then, the control device 40 will determine the display screen as the objective display device, and perform interactive control on the display screen based on the posture information of the user.

In one embodiment, the control device 40 determines which display device is in front of the user as the objective display device through a current judgment algorithm.

In one embodiment, a face recognition angle range can be set according to the installation angles between each of the display devices. When a face recognition angle between a face of a user and a display device is within the face recognition angle range, the control device 40 will determine such a display device as the objective display device and control the display device based on an interactive activities of the user. The face recognition angle range can be adjusted according to actual display requirements and the respective installation angles of each of the display devices. Each display device of the display device set 10 can have different face recognition angle ranges.

In one embodiment, when a face of a user is detected and the detected face of the user is within a predetermined orientation, the control device 40 is configured to choose and activate the corresponding display device associated with the face recognition device 60.

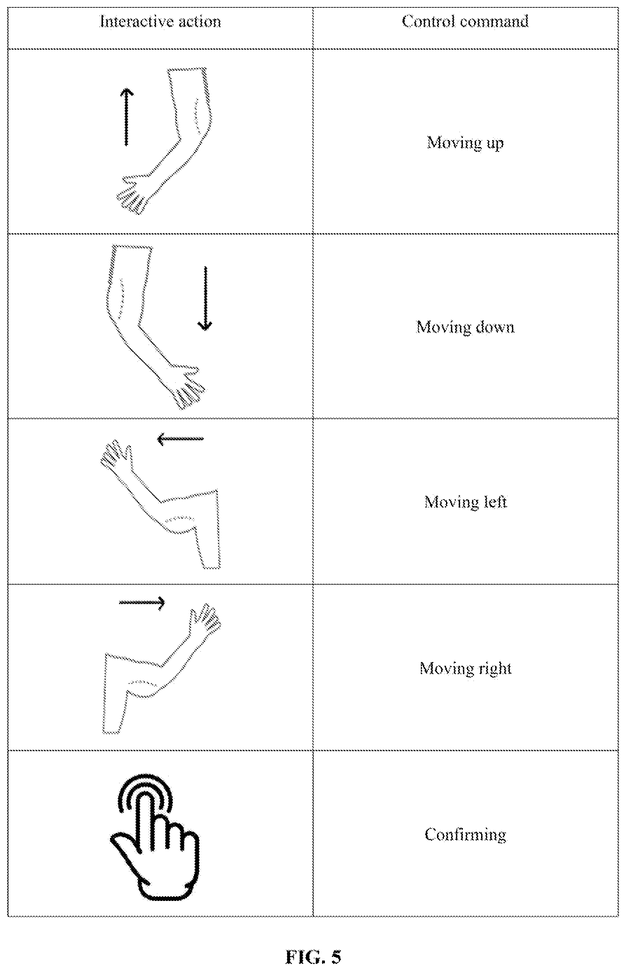

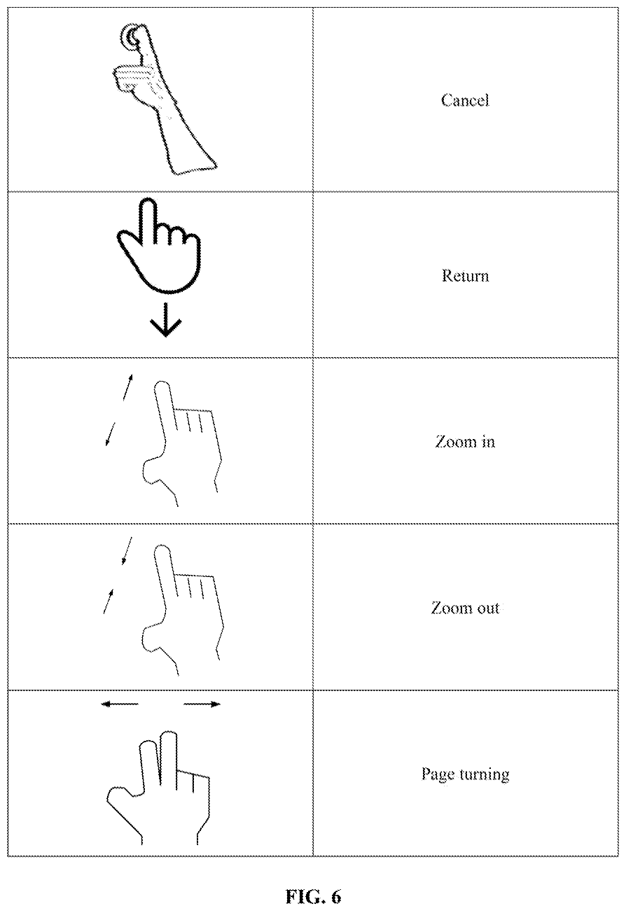

In one embodiment, the mapping relation between the multiple interactive activities and the multiple control commands can be predefined. The control device 40 can perform a control command corresponding to an interactive activities on the objective display device according to the mapping relation between the multiple interactive activities and the multiple control commands. FIGS. 5 and 6 show the mapping relation between the multiple interactive activities and the multiple control commands.

In one embodiment, the multiple control commands can comprise a movement up command, a movement down command, a movement left command, a movement right command, a page-turning command, a confirming command, a cancel command, a return command, a selecting command, a zoom-in command, and a zoom-out command. For example, a click action of a first gesture corresponding to the confirming command, and a click action of a second gesture corresponding to the cancel command.

In one embodiment, the installation angles between each of the display devices in the display device set 10 can be 0 to 360 degrees. For example, the installation angle between the display screen and the plane projection device can be 0 to 360 degrees, the installation angle between the display screen and the holographic projection device can be 0 to 360 degrees, and the installation angle between the plane projection device and the holographic projection device can be 0 to 360 degrees.

In one embodiment, if the display device set 10 is controlled using the voice controlled operation, for example, the display device set 10 is controlled by a first voice. The control device 40 is configured to choose a display device according to the first voice. The control device 40 further determines a control command represented by the first voice and performs an interactive control on the chosen display device accordingly.

In one embodiment, the control device 40 can determine a device name from the user voice and choose the display device according to the device name. For example, a first voice content is “display page 11”, a device name of the first voice content is “display”; a second voice content is “plane display page 8”, a device name of the second voice content is “plane”; a third voice content is “holo display picture nine”, a device name of the third voice content is “holo”, which corresponds to the holographic projection device.

In one embodiment, the system interface control operation can be that the display device set 10 is controlled by a system control interface, the system control interface can support touch control or access control of external devices. The system control interface can comprise a menu bar interface. The manually input control operation can be that the display device set 10 is controlled by a keyboard, a mouse, a brain-computer interface, etc.

In one embodiment, when the mixed control operation comprises interactive operation (for example the gesture controlled operation or the voice controlled operation), the control device 40 needs to determine which display device is the objective display device and what control command is represented by the current interactive content.

In on embodiment, the hybrid display system 100 can be used in scenarios relating to offices, education, training, product demos, home cinema, movie theater, KTVs, advertising displays, commercial performances, and industrial field teaching, etc. The hybrid display system 100 can show immersive scenes and render the displays more realistic, intuitive, and vivid. The hybrid display system 100 can enhance visual effects of education and training, the product demos, the home cinema, movie theater, the KTV studio, the advertising display, the commercial performance, and the industrial field teaching, and improve the interactive experience between the display technology and the voice or the action of the user. In comparison with Augmented Reality (AR) devices, Virtual Reality (VR) devices, and head-mounted mixed reality (MR) devices, the experience of the hybrid display system 100 is freer, more intuitive, and more immersive.

The embodiments shown and described above are only examples. Many details known in the relevant field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A hybrid display system comprising:
a display device set comprising at least two different types of display devices, wherein the two different types of display devices are selected from the group comprising of a display screen, a plane projection device, and a holographic projection device;
a sound playing device;
a content input device configured for inputting display content to the display device set and the sound playing device; and
a control device configured for allowing a user to set a display mode of the display device set;
wherein the display mode comprises an interactive display mode, a non-interactive display mode, and a hybrid display mode combining the interactive display mode and the non-interactive display mode; and
wherein when the display device set is controlled to operate in the interactive display mode, the control device is configured to determine a control command based on interactive activities of the user and choose the corresponding display device which is to be controlled by the control command.

2. The hybrid display system of claim 1, further comprising a user voice recognition device, a face recognition device, a user gesture recognition device, and a command input device for allowing the user to manually an input control command.

3. The hybrid display system of claim 1, wherein the content input device comprises a plurality of content transmission interfaces, each of the content transmission interfaces configured to allow transmission of the content to the respective display device in the non-interactive display mode.

4. The hybrid display system of claim 1, wherein the display content comprises labeled information, the labeled information configured for indicating corresponding display device for playing the display content.

5. The hybrid display system of claim 2, wherein when the display device set operates in the interactive display mode, operations of the display device set comprises a gesture controlled operation, a voice controlled operation, a system interface control operation, a manually input control operation and a mixed control operation; and the mixed control operation comprises at least two of the gesture controlled operation, the voice controlled operation, the system interface control operation, and the manually input control operation.

6. The hybrid display system of claim 5, wherein when the display device set is controlled under the gesture controlled operation, the control device is configured to choose the corresponding display device and control the corresponding display device according to gestures of the user.

7. The hybrid display system of claim 6, wherein when a face of a user is detected and the detected face of the user is within a predetermined orientation, the control device is configured to choose and activate the corresponding display device associated with the face recognition device.

8. The hybrid display system of claim 6, wherein the control device is configured to choose a display device that is activated a face recognition in front of a face of a user as the corresponding display device of the current gesture.

9. The hybrid display system of claim 5, wherein when the display device set is controlled using the voice controlled operation, the control device is configured to choose a display device according to a user voice, and execute a control command corresponding to the user voice on the chosen display device.

10. The hybrid display system of claim 9, wherein the control device is configured to determine a device name from the user voice and choose the display device according to the device name.

11. The hybrid display system of claim 1, wherein the installation angle between the display screen and the plane projection device is 180 degrees, the installation angle between the display screen and the holographic projection device is 90 degrees, and the installation angle between the plane projection device and the holographic projection device is 90 degrees.
